(19) United States
(12) Patent Application Publication
(10) Pub. No.: US 2011/0259222 A1
(43) Pub. Date: Oct. 27, 2011

(54) SCREEN PRINT MASK CLEANING UNIT, SCREEN PRINTING MACHINE, AND SCREEN PRINT MASK CLEANING METHOD

(75) Inventors: Tetsuya Tanaka, Yamanashi (JP); Seiko Abe, Yamanashi (JP)

(73) Assignee: PANASONIC CORPORATION, Osaka (JP)

(21) Appl. No.: 13/124,926

(22) PCT Filed: May 7, 2010
(86) PCT No.: PCT/JP2010/003146

§ 371 Date: Apr. 19, 2011

(30) Foreign Application Priority Data
May 25, 2009 (JP) 2009-124865

(51) Int. Cl. B41L 41/00; B41F 35/00; B08B 1/00

(52) U.S. Cl. 101/425; 134/6

(57) ABSTRACT

There is intended provision of a screen print mask cleaning unit that enables efficient wiping of paste from a screen print mask conforming to a cavity substrate, a screen printing machine, and a screen print mask cleaning method. A rubbing area 34a of a paper member 34 is rubbed against an undersurface of a mask region for a flat area (MRF), thereby wiping out paste PT adhering to the undersurface of the MRF. The rubbing area 34a of the paper member 34 is sequentially rubbed against undersurfaces of respective protruding portions 3a in a mask area for cavities (MRC), thereby wiping out the paste PT adhering to the undersurfaces of the respective protruding portions 3a. In the course of wiping of the paste PT adhering to the undersurfaces of the respective protruding portions 3a, the paper member 34 is taken up in a period from when the rubbing area 34a of the paper member 34 is separated apart from one protruding portion 3a until when the rubbing area 34a contacts another protruding portion 3a, thereby updating the rubbing area 34a of the paper member 34.

### TECHNICAL FIELD

The present invention relates to a screen print mask cleaning unit that wipes out paste adhering to an undersurface of the screen print mask, a screen printing machine, and a screen print mask cleaning method.

BACKGROUND ART

In relation to a screen print mask (hereinafter simply called a “mask”) used while held in contact with a substrate when paste, such as solder paste, is printed on electrodes of the substrate, it is necessary to wipe out the paste adhering to a mask resultant of separation of the mask, thereby preparing for the next screen printing operation. The cleaning unit for wiping out the paste adhering to such a mask is configured so as to wipe out the paste adhering to the mask by bringing a predetermined area (a rubbing area) of a paper member rubbed against the undersurface of the mask (see; for instance, Patent Document 1).

Incidentally, of substrates, there has hitherto been known a so-called cavity substrate including electrodes provided on bottom surfaces of respective indented openings (cavities) formed in an upper surface of the substrate as well as electrodes provided on the upper surface (a flat area) of the substrate. Since the cavity substrate has cavity electrodes provided in the respective cavities and flat electrodes provided on the flat area, a mask conforming to the cavity substrate has pattern apertures conforming to the cavity electrodes and pattern apertures conforming to the flat electrodes. In this case, the mask has a plurality of protruding portions that downwardly protrude and that are to be fitted into the respective cavities. Pattern apertures conforming to the cavity electrodes are formed in bottom surfaces of the respective protruding portions.

The mask conforming to the cavity substrate can be realized in the form of a geometry such that a mask region for cavities having pattern apertures which correspond to the cavity electrodes and which are formed in respective bottom surfaces of the plurality of protruding portions and a mask region for a flat area which correspond to the flat electrodes having pattern apertures and which are formed in the flat area exist as mutually-different regions. Thereupon, when cleaning of such a mask is carried out, all you need to do is to perform cleaning that is performed by sequentially rubbing a rubbing area of a paper member against undersurfaces of the respective protruding portions in the mask region for cavities and cleaning that is performed by rubbing the rubbing area of the paper member against the undersurface of the mask region for a flat area. Cleaning of the mask can readily be performed.

### RELATED ART DOCUMENT

### Patent Document

Patent Document 1: JP-A-2004-66832

### DISCLOSURE OF THE INVENTION

### Problem that the Invention is to Solve

However, as mentioned above, in a case where the rubbing area of the paper member is sequentially rubbed against the undersurfaces of the respective protruding portions, when the paper member moved off from one protruding portion after having finished cleaning the protruding portion contacts another protruding portion, the paste wiped out from the preceding protruding portion is sometimes adhered to a subsequent protruding portion by means of rubbing action. If the paste wiped out from the preceding protruding portion is adhered to the subsequent protruding portion by means of rubbing action, the thus-adhered paste must also be wiped out through operation for cleaning the subsequent protruding portion. There exists a problem of cleaning efficiency being often deteriorated for this reason.

Accordingly, the present invention aims at providing a screen print mask cleaning unit that enables efficient wiping of paste from a screen print mask conforming to a cavity substrate, a screen printing machine, and a screen print mask cleaning method.

### Means for Solving the Problem

A cleaning unit for a screen print mask of the present invention is a screen print mask cleaning unit that wipes out paste adhering to an undersurface of a screen print mask having a flat-plate-like first mask region and a second mask region which is provided as a region differing from the first mask region and which has a plurality of downwardly-projecting protruding portions, the cleaning unit comprising:

a paper member having a rubbing area to be rubbed against the undersurface of the screen print mask;

a paper member rubbing device that rubs the rubbing area of the paper member against an undersurface of the first mask region, thereby wiping out the paste adhering to the undersurface of the first mask region and sequentially rubs the rubbing area of the paper member against undersurfaces of the respective protruding portions in the second mask region, thereby wiping out the paste adhering to the undersurfaces of the respective protruding portions; and

a rubbing area update device that takes up the paper member in a period from when the rubbing area of the paper member is separated apart from one protruding portion until when the rubbing area contacts another protruding portion, thereby updating the rubbing area of the paper member.

A screen printing machine of the present invention is a screen printing machine that subjects to screen printing a plurality of first electrodes provided on an upper surface of a substrate and a plurality of second electrodes provided on respective bottom surfaces of a plurality of apertures formed in portions of the upper surface of the substrate, the screen printing machine comprising:

a screen print mask having
a flat-plate-like first mask region that is used while remaining in contact with the upper surface of the substrate and that has first pattern apertures formed in correspondence with the first electrodes and
a second mask region that is provided as a region differing from the first mask region and that has second pattern apertures formed, in correspondence with the plurality of second electrodes, in the plurality of respective downwardly-projecting protruding portions which are to fit into the corresponding apertures of the substrate;

a print execution device that feeds paste into the second mask region while the second pattern apertures made in the second mask region of the screen print mask and the second electrodes of the substrate are held in agreement with each other, subsequently separates the screen mask relatively apart from the substrate, thereby printing the paste onto the second electrodes, feeds paste into the first mask region while the first pattern apertures made in the first mask region of the screen print mask and the first electrodes of the substrate remain in agreement with each other, and subsequently separates the screen print mask relatively apart from the substrate, thereby printing the paste to the first electrodes; and

a screen print mask cleaning unit that wipes out the paste adhering to an undersurface of the screen print, wherein

the screen print mask cleaning unit includes a paper member having a rubbing area to be rubbed against the undersurface of the screen print mask;
a paper member rubbing device that rubs the rubbing area of the paper member against an undersurface of the first mask region, thereby wiping out the paste adhering to the undersurface of the first mask region and sequentially rubs the rubbing area of the paper member against undersurfaces of the respective protruding portions in the second mask region, thereby wiping out the paste adhering to the undersurfaces of the respective protruding portions; and
a rubbing area update device that takes up the paper member in a period from when the rubbing area of the paper member is separated apart from one protruding portion until when the rubbing area contacts another protruding portion, thereby updating the rubbing area of the paper member.

A screen print mask cleaning method of the present invention is a screen print mask cleaning method for wiping out paste adhering to an undersurface of a screen print mask having a flat-plate-like first mask region and a second mask region which is provided as a region differing from the first mask region and which has a plurality of downwardly-projecting protruding portions, the method comprising:

a step of wiping out the paste adhering to an undersurface of the first mask region by rubbing a rubbing area of a paper member against the undersurface of the first mask region; and

a step of sequentially rubbing the rubbing area of the paper member against undersurfaces of the respective protruding portions in the second mask region, thereby wiping out the paste adhering to the undersurfaces of the respective protruding portions, wherein, in the step of sequentially rubbing the rubbing area of the paper member against the under surfaces of the respective protruding portions in the second mask region, thereby wiping out the paste adhering to the undersurfaces of the respective protruding portions, the paper member is taken up in a period from when the rubbing area of the paper member is separated apart from one protruding portion until when the rubbing area contacts another protruding portion, thereby updating the rubbing area of the paper member.

### Advantage of the Invention

In the present invention, the paper member is taken up in a period from when the rubbing area of the paper member is separated from one protruding portion until when the rubbing area contacts another protruding portion. Consequently, when the paper member that was separated from one protruding portion after having cleaned the same contacts another protruding portion, the paste wiped out from the preceding protruding portion will be prevented from being rubbed against the next protruding portion. For this reason, it is possible to efficiently wipe out the paste from the screen print mask conforming to a cavity substrate.

### BRIEF DESCRIPTION OF THE DRAWINGS

FIG. 1 It is a schematic diagram of a screen printing machine of an embodiment of the present invention.

FIG. 2(a) it is a plan view of a cavity substrate that is an object of printing operation of the screen printing machine of the embodiment of the present invention, and (b) it is a side cross sectional view of the same.

FIG. 3(a) it is a plan view of a mask provided in the screen printing machine of the embodiment of the present invention, and (b) it is a side cross sectional view of the same.

FIG. 4(a), (b), (c), and (d) they are descriptive views of operation of the screen printing machine of the embodiment of the present invention.

FIG. 5(a), (b), (c), and (d) they are descriptive views of operation of the screen printing machine of the embodiment of the present invention.

FIG. 6 It is a descriptive view of operation of a cleaning unit provided in the screen printing machine of the embodiment of the present invention.

FIG. 7(a), (b), (c), and (d) they are descriptive views of operation of the cleaning unit provided in the screen printing machine of the embodiment of the present invention.

### MODE FOR IMPLEMENTING THE INVENTION

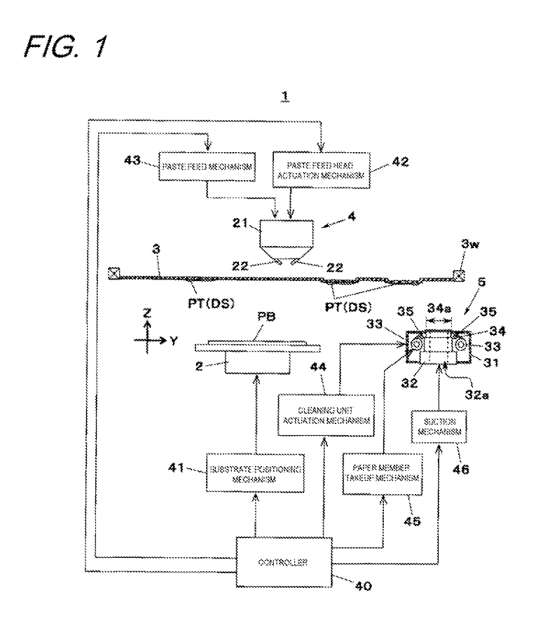

An embodiment of the present invention is hereunder described by reference to the drawings. In FIG. 1, a screen printing machine 1 of the embodiment includes a substrate holding block 2 that holds a substrate PB that is an object of printing; a screen print mask (hereinafter simply called a “mask”) 3 that is horizontally placed above the substrate PB held by the substrate holding block 2 and that wholly assumes an oblong shape; a paste feed head 4 provided above the mask 3; and a cleaning unit 5 that contacts from below an undersurface of the mask 3 and that cleans the mask 3 after the screen printing machine 1 has finished performing screen printing. For the sake of explanation, a direction of a short side of the mask 3 (a direction perpendicular to a drawing sheet of FIG. 1) is taken as an X-axis direction; a direction of a long side of the mask 3 (a horizontal direction of the drawing sheet of FIG. 1) is taken as a Y-axis direction; and a thicknesswise direction of the mask 3 (a vertical direction of the drawing sheet of FIG. 1) is taken as a Z-axis direction.

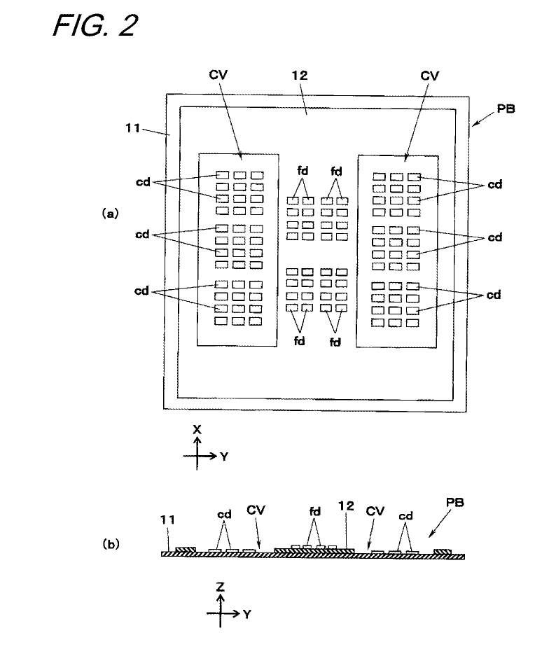

The substrate PB shown in FIGS. 2(a) and (b) includes a lower-layer-side substrate member 11 and an upper-layer-side substrate member 12 bonded to an upper surface of the lower-layer-side substrate member 11. A plurality of flat electrodes fd (first electrodes) are provided on an upper surface of the substrate PB (the upper-layer-side substrate member 12). Further, a plurality of cavity electrodes cd (second electrodes) are placed on bottom surfaces of cavities CV (i.e., the upper surface of the lower-layer-side substrate member 11) that are apertures provided in portions of the upper surface of the upper-layer-side substrate member 12. Specifically, the substrate PB is a cavity substrate that includes the plurality of flat electrodes fd provided on the upper surface (the upper surface of the upper-layer-side substrate member 12) and the plurality of cavity electrodes cd provided on the respective bottom surfaces of the cavities CV (the upper surface of the lower-layer-side substrate member 11).

The substrate holding block 2 is provided so as to be movable in a direction within a horizontal plane (i.e., a direction in an X-Y plane) and a vertical direction (i.e., the Z-axis direction) and can position the thus-held substrate PB at an arbitrary location below the mask 3.

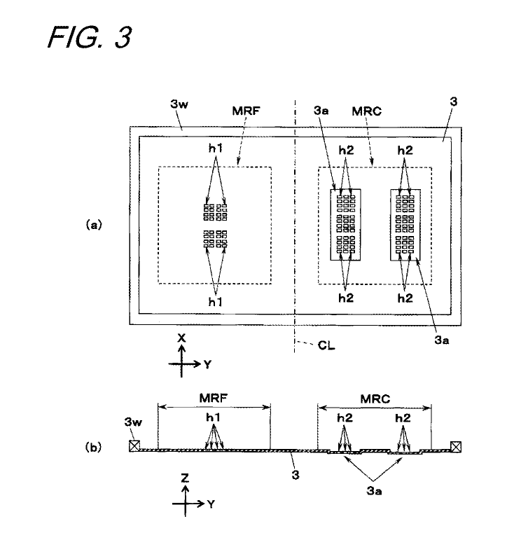

In FIGS. 1 and 3(a), (b), four sides of the mask 3 are supported by a frame member 3w. A mask region for a flat area (MRF) and a mask region for cavities (MRC) that are mutually different areas are provided within a rectangular area surrounded by the frame member 3w. A plurality of first pattern apertures h1 corresponding to the plurality of flat electrodes fd provided on the upper surface of the upper-layer-side substrate member 12 are provided in the MRF. Meanwhile, a plurality of protruding portions 3a that downwardly protrude so as to fit respectively into the plurality of cavities CV of the substrate PB are provided in the MRC. A plurality of second pattern apertures h2 corresponding to the plurality of cavity electrodes cd provided on the upper surface (the bottom surfaces of the cavities CV) of the lower-layer-side substrate member 11 are provided in each of the protruding portions 3a.

As can be seen from FIG. 3(a), the MRF is made up of one of two areas of the mask 3 that are situated with a center line CL of the mask 3, which is parallel to a direction of a short side of the mask 3 (an X-axis direction), interposed therebetween. The MRC is made up of the other one of the two areas of the mask 3 that are situated with the center line CL interposed therebetween. The mask 3 of the present embodiment is thus formed as a mask conforming to a cavity substrate including the flat-plate-like MRF (a first mask region) and the MRC (a second mask region) that is provided as a region differing from the MRF and that includes the plurality of downwardly-projecting protruding portions 3a.

In FIG. 1, the paste feed head 4 has a head main body 21 that is provided so as to be movable in a direction within the horizontal plane (a direction within an X-Y plane) and a vertical direction (a Z-axis direction) with respect to the mask 3 and two guide members 22 that are provided on a lower portion of the head main body 21 and that oppose each other along the Y-axis direction. Each of the guide members 22 is a spatula-like member extending in the X-axis direction. The guide members 22 guide paste, such as solder paste and conductive paste, fed (pumped) in a downward direction from a paste cartridge (not shown) accommodated in the head main body 21 such that the paste is intensively fed to a target position on the mask 3.

In FIG. 1, the cleaning unit 5 has a case-like base block 31 that is provided so as to be movable in both a direction within the horizontal plane (a direction within the X-Y plane) and the vertical direction (the Z-axis direction); an upwardly opened backup member 32 provided in the base block 31; a pair of takeup rollers 33 that are disposed opposite each other in the Y-axis direction with the backup member 32 interposed therebetween and that are rotatable around the X axis; a paper member 34 extended across the pair of takeup rollers 33; and a pair of guide rollers 35 that are disposed between the pair of takeup rollers 33 along the Y-axis direction with the backup member 32 interposed therebetween and that are rotatable around the X axis.

An upper surface of the paper member 34 is an adhesive surface. A horizontal area of the paper member supported by the backup member 32 between the pair of guide rollers 35 acts as a rubbing area 34a that is to be rubbed against an undersurface of the mask 3 from below. The rubbing area 34a of the paper member 34 can be updated by rotating the pair of takeup rollers 33 in a single direction to take up the paper member 34. An upwardly-opened air suction conduit 32a is formed in the backup member 32. Air is drawn from the air suction conduit 32a by vacuum aspiration, whereby air can be drawn into the air suction conduit 32a by way of the rubbing area 34a of the paper member 34.

Operation for positioning the substrate PB with respect to the mask 3 resultant from movement of the substrate holding block 2 in a direction within the horizontal plane and in the vertical direction is fulfilled by means of a controller 40 (FIG. 1) provided in the screen printing machine 1 controlling operation of a substrate positioning mechanism 41 (FIG. 1) made up of an unillustrated actuator, or the like.

Operation for positioning the paste feed head 4 with respect to the mask 3 resultant from movement of the head main body 21 of the paste feed head 4 in a direction within the horizontal plane and in the vertical direction is fulfilled by means of the controller 40 controlling operation of a paste feed head actuation mechanism 42 (FIG. 1) made up of an unillustrated actuator, or the like. Operation for feeding paste from the paste feed head 4 is fulfilled by means of the controller 40 controlling operation of a paste feed mechanism 43 (FIG. 1) made up of an unillustrated actuator.

Operation for positioning and relatively moving the cleaning unit 5 with respect to the mask 3 resultant from movement of the base block 31 of the cleaning unit 5 in a direction within the horizontal plane and in the vertical direction is fulfilled by means of the controller 40 controlling operation of a cleaning unit actuation mechanism 44 (FIG. 1) made up of an unillustrated actuator, or the like. Moreover, operation for taking up the paper member 34 performed by the pair of takeup rollers 33 (operation for updating the rubbing area 34a of the paper member 34) is fulfilled by means of the controller 40 controlling operation of a paper member takeup mechanism 45 (FIG. 1) made up of an unillustrated actuator, or the like. Operation for drawing air from the air suction conduit 32a by means of vacuum aspiration is fulfilled by means of the controller 40 controlling operation of a suction mechanism 46 made up of an unillustrated actuator, or the like.

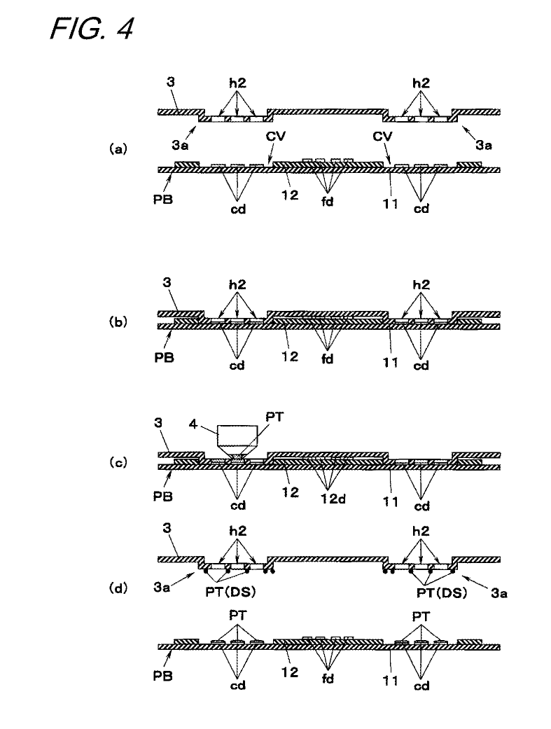

In a process during which the screen printing machine 1 subjects the substrate PB to screen printing, the controller 40 first moves the substrate PB in such a way that the second pattern apertures h2 made in the MRC of the mask 3 and the respective cavity electrodes cd of the substrate PB held by the substrate holding block 2 come into agreement with each other in the vertical direction (FIG. 4(a)), and subsequently elevates the substrate PB, to thus bring the upper surface of the substrate PB into contact with the undersurface of the mask 3 (FIG. 4(b)). The protruding portions 3a of the mask 3 and the cavities CV of the substrate PB are thereby fit to each other in the vertical direction, whereupon the respective second pattern apertures h2 made in the MRC and the cavity electrodes cd of the substrate PB come into agreement with each other in the vertical direction (a positioning process).

The controller 40 brings the upper surface of the substrate PB into contact with the undersurface of the mask 3; subsequently brings the guide members 22 of the paste feed head 4 into contact with an upper surface of the mask 3; and thereupon activates the paste feed mechanism 43, thereby feeding paste PT into the MRC (the protruding portions 3a) (FIG. 4(c): a paste feed process). The paste PT is thereby fed onto the respective cavity electrodes cd by way of the respective second pattern apertures h2 in the MRC. Accordingly, the paste PT is printed (transferred) to the respective cavity electrodes cd by subsequently separating the substrate PB relatively apart from the mask 3 in the vertical direction (a mask separation process) (FIG. 4(d)).

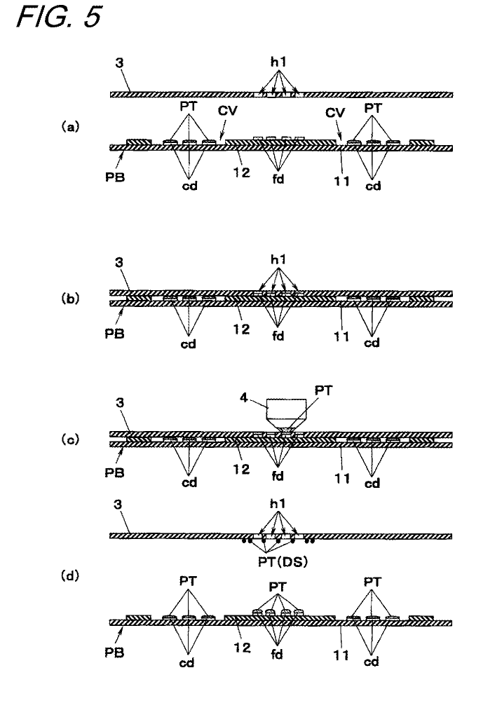

The controller 40 next moves the substrate PB in such a way that the respective first pattern apertures h1 in the MRF of the mask 3 oppose the respective flat electrodes fd of the substrate PB held by the substrate holding block 2 in the vertical direction (FIG. 5(a)) and subsequently elevates the substrate PB, to thus bring the upper surface of the substrate PB into contact with the undersurface of the mask 3 (FIG. 5(b)). The respective first pattern apertures h1 in the MRF of the mask 3 thereby come into agreement with the respective flat electrodes fd of the substrate PB in the vertical direction.

The controller 40 brings the upper surface of the substrate PB into contact with the undersurface of the mask 3 and subsequently brings the guide members 22 of the paste feed head 4 into contact with the upper surface of the mask 3. The controller 40 then activates the paste feed mechanism 43, to thus feed the paste PT into the MRF (FIG. 5(c)). The paste PT is thereby fed onto the respective flat electrodes fd by way of the respective first pattern apertures h1 in the MRF. Hence, the paste PT is printed to the respective flat electrodes fd by subsequently separating the substrate PB relatively apart from the mask 3 in the vertical direction (FIG. 5(d)).

The cavity electrodes cd are provided in the respective indented cavities CV in the upper surface of the substrate PB. Hence, even if the mask 3 is brought into contact with the upper surface of the substrate PB after the paste PT has been printed to the cavity electrodes cd, the mask 3 will not contact the paste PT on the respective cavity electrodes cd.

After having completed processing pertaining to the screen print execution process, the controller 40 performs cleaning of the undersurface of the mask 3 by means of the cleaning unit 5. During operation for cleaning the undersurface of the mask 3, cleaning of the MRC and cleaning of the MRF are separately performed.

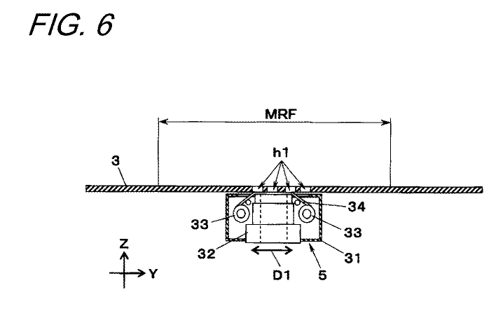

During cleaning of the MRF of the mask 3, the controller 40 controls operation of the cleaning unit actuation mechanism 44 as shown in FIG. 6, brings the rubbing area 34a of the paper member 34 of the cleaning unit 5 into contact with an undersurface of the MRF, and thereupon actuates the base block 31 in a direction within the horizontal plane (the Y-axis direction in this case) (an arrow D1 shown in FIG. 6). The paste PT (residues DS of the paste PT, and see FIG. 5(d)) adhering to the undersurface of the MRF of the mask 3 thereupon adhere to the rubbing area 34a of the paper member 34, so that the paste PT can be wiped out from the undersurface of the MRF of the mask 3 (a process for wiping out paste from an MRF).

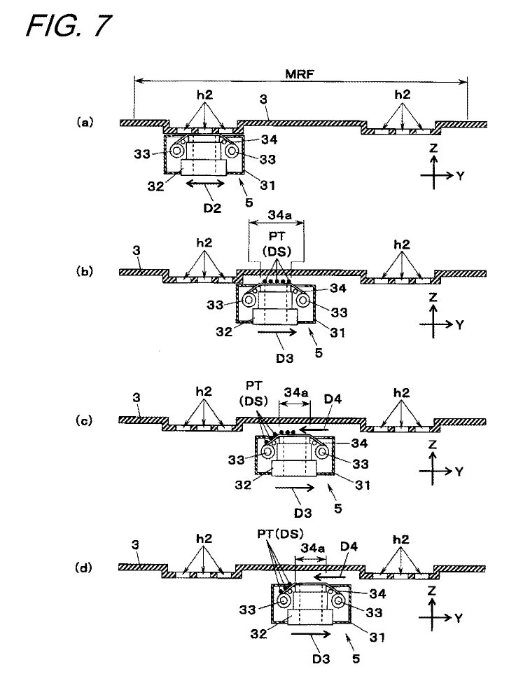

In the meantime, during operation for cleaning the MRC of the mask 3, the controller 40 controls operation of the cleaning unit actuation mechanism 44 as shown in FIG. 7(a), thereby bringing the rubbing area 34a of the paper member 34 of the cleaning unit 5 into contact with an undersurface of one of the protruding portions 3a in the MRC and actuating the base block 31 in a direction within the horizontal plane (the Y-axis direction in the embodiment) in this state (as indicated by arrow D2 shown in FIG. 7(a)). The paste PT (the residues DS of the paste PT, and see FIG. 4(d)) adhering to an undersurface of the MRC of the mask 3 thereupon adhere to the rubbing area 34a of the paper member 34, so that the paste PT can be wiped out from the undersurface of the MRC of the mask 3.

After having finished cleaning the undersurface of one protruding portion 3a, the controller 40 moves the rubbing area to another (an adjacent) protruding portion 3a (as designated by an arrow D3 shown in FIGS. 7(b), (c), and (d)), thereby cleaning an undersurface of the protruding portion 3a. The paste PT can thereby be wiped out from the undersurfaces of all of the protruding portions 3 (a process for wiping out paste from the MRC).

When wiping out the paste PT in these paste wiping processes, the controller 40 controls operation of the suction mechanism 46 and draws air from the air suction conduit 32a by way of the rubbing area 34a of the paper member 34 through vacuum aspiration. The paste PT adhering to the undersurface of the mask 3 is thereby drawn to the paper member 34, so that wiping of the paste PT can be performed more effectively.

Incidentally, in a process for wiping out the paste PT adhering to the undersurfaces of the respective protruding portions 3a by sequentially rubbing the rubbing area 34a of the paper member 34 against the undersurfaces of the respective protruding portions 3a in the MRC, the controller 40 activates the paper member takeup mechanism 45 during a period from when the rubbing area 34a of the paper member 34 is separated apart from one protruding portion 3a until when the rubbing area contacts another protruding portion 3a, and takes up the paper member 34. The rubbing area 34a of the paper member 34 is thereby updated (as designated by an arrow D4 shown in FIGS. 7(c) and (d): a rubbing area update process). The residues DS of the paste PT adhering to the paper member 34 are removed (FIGS. 7(b), (c), and (d)), so that the paste PT wiped out from the preceding protruding portion 3a is prevented from being rubbed against the next protruding portion 3a.

As described above, the cleaning unit 5 for the screen print mask 3 of the present embodiment includes the paper member 34 having the rubbing area 34a to be rubbed against the undersurface of the mask 3; a paper member rubbing device (the cleaning unit actuation mechanism 44 and the controller 40) that rubs the rubbing area 34a of the paper member 34 against the undersurface of the MRF (the first mask region) of the mask 3, thereby wiping out the paste PT adhering to the undersurface of the MRF and sequentially rubs the rubbing area 34a of the paper member 34 against the undersurfaces of the respective protruding portions 3a in the MRC (the second mask region), thereby wiping out the paste PT adhering to the undersurfaces of the respective protruding portions 3a; and a rubbing area update device (the paper member takeup mechanism 45 and the controller 40) that takes up the paper member 34 in a period from when the rubbing area 34a of the paper member 34 is separated apart from one protruding portion 3a until when the rubbing area 34a contacts another protruding portion 3a, thereby updating the rubbing area 34a of the paper member 34.

The method for cleaning the screen print mask 3 of the present embodiment is configured such that there is performed processing pertaining to a process of wiping out the paste PT adhering to the undersurface of the MRF by rubbing the rubbing area 34a of the paper member 34 against the under surface of the MRF (the first mask region) (a step of wiping out paste from the MRF); processing pertaining to a process of wiping out the paste PT adhering to the undersurfaces of the respective protruding portions 3a by sequentially rubbing the rubbing area 34a of the paper member 34 against the undersurfaces of the respective protruding portions 3a in the MRC (the second mask region) (a step of wiping out paste from the MRC); and a process of updating the rubbing area 34a of the paper member 34 by taking up the paper member 34 in a period from when the rubbing area 34a of the paper member 34 is separated apart from one protruding portion 3a in the step of wiping out paste from the MRC until when the rubbing area contacts another protruding portion 3a (a rubbing area update step).

As mentioned above, in the present embodiment, the paper member 34 is taken up in a period from when the rubbing area 34a of the paper member 34 is separated apart from one protruding portion 3a and until when the rubbing area contacts the other protruding area 3a, whereupon the rubbing area 34a of the paper member 34 is updated. When the paper member 34, which was separated from one protruding portion 3a after having cleaned the same, comes into contact with another protruding portion 3a, the paste PT wiped out from the preceding protruding portion 3a will not be rubbed against the next protruding portion 3a. Therefore, the paste PT can efficiently be wiped out from the screen print mask 3 conforming to the cavity substrate.

The screen printing machine 1 of the present embodiment is the screen printing machine 1 that subjects to screen printing the plurality of flat electrodes fd (the first electrodes) provided on the upper surface of the substrate PB and the plurality of cavity electrodes cd (the second electrodes) provided on the respective bottom surfaces of the plurality of cavities CV (the apertures) formed in portions of the upper surface of the substrate PB. The screen printing machine 1 includes the mask 3. The mask 3 has the flat-plate-like MRF (the first mask region) that is used while remaining in contact with the upper surface of the substrate PB and that has the first pattern apertures h1 formed, in correspondence with the flat electrodes fd. The mask also has the MRC (the second mask region) that is provided as a region differing from the MRF and that has the second pattern apertures h2 formed, in correspondence with the respective cavity electrodes cd, in the plurality of downwardly-projecting protruding portions 3a to fit into the corresponding apertures (the cavities CV) of the substrate PB. The screen printing machine also has a print execution device (the paste feed head 4, the substrate holding block 2, the paste feed mechanism 43, a substrate positioning mechanism 41, and the controller 40). The printing execution device feeds the paste PT into the MRC while the second pattern apertures h2 made in the MRC of the mask 3 and the cavity electrodes cd of the substrate PB are held in agreement with each other; subsequently separates the mask 3 relatively apart from the substrate PB, thereby printing the paste PT onto the cavity electrodes cd. The printing execution device also feeds the paste PT into the MRF while the first pattern apertures h1 made in the MRF of the mask 3 and the flat electrodes fd of the substrate PB remain in agreement with each other. The printing execution device subsequently separates the mask 3 relatively apart from the substrate PB, thereby printing the paste PT to the flat electrodes fd. The screen printing machine 1 also has the cleaning unit 5 that wipes out the paste PT adhering to the undersurface of the mask 3.

In such a screen printing machine, the MRF can be cleaned without being interrupted by the protruding portions 3a in the MRC. Therefore, the three-dimensional screen print mask 3 conforming to the cavity substrate can be well cleaned.

Although the embodiment of the present invention has been described thus far, the present invention is not limited to the aforementioned embodiment. For instance, in the embodiment, the undersurface of the MRC is cleaned after the undersurface of the MRF has been cleaned. The cleaning sequence can also be reversed.

The present patent application is based on Japanese Patent Application (JP-A-2009-124865) filed on May 25, 2009, the entire subject matter of which is incorporated herein by reference.

### INDUSTRIAL APPLICABILITY

There are provided a screen print mask cleaning unit and a screen print mask cleaning method that enable efficient wiping of paste from the screen print mask conforming to a cavity substrate.

### DESCRIPTIONS OF THE REFERENCE NUMERALS AND SYMBOLS

1 SCREEN PRINTING MACHINE
2 SUBSTRATE HOLDING BLOCK (PRINT EXECUTION DEVICE)
3 SCREEN PRINT MASK
3a PROTRUDING PORTION
4 PASTE FEED HEAD (PRINT EXECUTION DEVICE)
5 CLEANING UNIT
34 PAPER MEMBER
34a RUBBING AREA
40 CONTROLLER (PAPER MEMBER RUBBING DEVICE, RIBBING AREA UPDATE DEVICE, PRINT EXECUTION DEVICE)
41 SUBSTRATE POSITIONING MECHANISM (PRINT EXECUTION DEVICE)
43 PASTE FEED MECHANISM (PRINT EXECUTION DEVICE)
44 CLEANING UNIT (PAPER MEMBER RUBBING DEVICE)
45 PAPER MEMBER TAKEUP MECHANISM (RUBBING AREA UPDATE DEVICE)
MRF MASK REGION FOR FLAT AREA (FIRST MASK REGION)
MRC MASK REGION FOR CAVITIES (SECOND MASK REGION)
h1 FIRST PATTERN APERTURE
h2 SECOND PATTERN APERTURE
PB SUBSTRATE
CV CAVITY (APERTURE)
fd FLAT ELECTRODE (FIRST ELECTRODE)
cd CAVITY ELECTRODE (SECOND ELECTRODE)
PT PASTE

### FIG. 1

42 PASTE FEED HEAD ACTUATION MECHANISM
43 PASTE FEED MECHANISM
44 CLEANING UNIT ACTUATION MECHANISM
41 SUBSTRATE POSITIONING MECHANISM
40 CONTROLLER
46 SUCTION MECHANISM
45 PAPER MEMBER TAKEUP MECHANISM

1. A screen print mask cleaning unit that wipes out paste adhering to an undersurface of a screen print mask having a flat-plate-like first mask region and a second mask region which is provided as a region differing from the first mask region and which has a plurality of downwardly-projecting protruding portions, the cleaning unit comprising:
a paper member having a rubbing area to be rubbed against the undersurface of the screen print mask;
a paper member rubbing device that rubs the rubbing area of the paper member against an undersurface of the first mask region, thereby wiping out the paste adhering to the undersurface of the first mask region and sequentially rubs the rubbing area of the paper member against undersurfaces of the respective protruding portions in the second mask region, thereby wiping out the paste adhering to the undersurfaces of the respective protruding portions; and
a rubbing area update device that takes up the paper member in a period from when the rubbing area of the paper member is separated apart from one protruding portion until when the rubbing area contacts another protruding portion, thereby updating the rubbing area of the paper member.

2. A screen printing machine that subjects to screen printing a plurality of first electrodes provided on an upper surface of a substrate and a plurality of second electrodes provided on respective bottom surfaces of a plurality of apertures formed in portions of the upper surface of the substrate, the screen printing machine comprising:
a screen print mask having
a flat-plate-like first mask region that is used while remaining in contact with the upper surface of the substrate and that has first pattern apertures formed in correspondence with the first electrodes and
a second mask region that is provided as a region differing from the first mask region and that has second pattern apertures formed, in correspondence with the plurality of second electrodes, in the plurality of respective downwardly-projecting protruding portions which are to fit into the corresponding apertures of the substrate;
a print execution device that feeds paste into the second mask region while the second pattern apertures made in the second mask region of the screen print mask and the second electrodes of the substrate are held in agreement with each other, subsequently separates the screen print mask relatively apart from the substrate, thereby printing the paste onto the second electrodes, feeds paste into the first mask region while the first pattern apertures made in the first mask region of the screen print mask and the first electrodes of the substrate remain in agreement with each other, and subsequently separates the screen print mask relatively apart from the substrate, thereby printing the paste to the first electrodes; and
a screen print mask cleaning unit that wipes out the paste adhering to an undersurface of the screen print mask, wherein
the screen print mask cleaning unit includes
a paper member having a rubbing area to be rubbed against the undersurface of the screen print mask;
a paper member rubbing device that rubs the rubbing area of the paper member against an undersurface of the first mask region, thereby wiping out the paste adhering to the undersurface of the first mask region and sequentially rubs the rubbing area of the paper member against undersurfaces of the respective protruding portions in the second mask region, thereby wiping out the paste adhering to the undersurfaces of the respective protruding portions; and
a rubbing area update device that takes up the paper member in a period from when the rubbing area of a paper member is separated apart from one protruding portion until when the rubbing area contacts another protruding portion.

3. A screen print mask cleaning method for wiping out paste adhering to an undersurface of a screen print mask having a flat-plate-like first mask region and a second mask region which is provided as a region differing from the first mask region and which has a plurality of downwardly-projecting protruding portions, the method comprising:
a step of wiping out the paste adhering to an undersurface of the first mask region by rubbing a rubbing area of the paper member against the undersurface of the first mask region, thereby wiping out the paste adhering to the undersurface of the first mask region; and
a step of sequentially rubbing the rubbing area of the paper member against undersurfaces of the respective protruding portions in the second mask region, thereby wiping out the paste adhering to the undersurfaces of the respective protruding portions, wherein, in the step of sequentially rubbing the rubbing area of the paper member against the under surfaces of the respective protruding portions in the second mask region, thereby wiping out the paste adhering to the undersurfaces of the respective protruding portions, the paper member is taken up in a period from when the rubbing area of the paper member is separated apart from one protruding portion until when the rubbing area contacts another protruding portion, thereby updating the rubbing area of the paper member.
